(19) United States
(12) Patent Application Publication
(10) Pub. No.: US 2023/0043057 A1
(43) Pub. Date: Feb. 9, 2023

(54) COMPUTER-READABLE RECORDING MEDIUM STORING APPLICATION CONTROL PROGRAM AND APPLICATION CONTROL METHOD

(71) Applicant: FUJITSU LIMITED, Kawasaki-shi (JP)

(72) Inventor: Keiji Miyazaki, Kawasaki (JP)

(73) Assignee: FUJITSU LIMITED, Kawasaki-shi (JP)

(21) Appl. No.: 17/726,584

(22) Filed: Apr. 22, 2022

(30) Foreign Application Priority Data
Aug. 4, 2021 (JP) 2021-128274

(51) Int. Cl. G06F 9/455; G06F 9/48

(52) U.S. Cl. CPC G06F 9/45558; G06F 9/4881; G06F 2009/45562; G06F 2009/45595; G06F 2009/45579

(57) ABSTRACT

A recording medium stores an application control program for causing a computer to execute processing including: when a specific application included in a applications is executed in response to a processing request from a specific processing request source, referring to a storage unit that stores flow information that indicates a past execution order of the applications for each of the processing request sources of the applications, and calculating an execution probability that each of one or more applications that are likely to be executed after the specific application executed in response to the processing request from the specific processing request source among the applications is executed after the specific application executed in response to the processing request from the specific processing request source; specifying an application to be activated from the one or more applications based on the calculated execution probability; and activating the specified application to be activated.

### CROSS-REFERENCE TO RELATED APPLICATION

This application is based upon and claims the benefit of priority of the prior Japanese Patent Application No. 2021-128274, filed on Aug. 4, 2021, the entire contents of which are incorporated herein by reference.

### FIELD

The embodiments discussed herein are related to an application control program and an application control method.

### BACKGROUND

For example, a business operator who provides a service to a user (hereinafter, simply referred to as business operator) constructs and operates a business system used to provide the service (hereinafter, also referred to as information processing system).

Japanese Laid-open Patent Publication No. 2014-170353 and U.S. Pat. No. 09,720,709 are disclosed as related art.

### SUMMARY

According to an aspect of the embodiments, a non-transitory computer-readable recording medium stores an application control program for causing a computer to execute processing including: in a case where a specific application included in a plurality of applications is executed in response to a processing request from a specific processing request source, referring to a storage unit that stores flow information that indicates a past execution order of the plurality of applications for each of the processing request sources of the plurality of applications, and calculating an execution probability that each of one or more applications that are likely to be executed after the specific application executed in response to the processing request from the specific processing request source among the plurality of applications is executed after the specific application executed in response to the processing request from the specific processing request source; specifying an application to be activated from the one or more applications on a basis of the calculated execution probability; and activating the specified application to be activated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a configuration of an information processing system 10;

FIG. 2 is a diagram for describing a specific example of processing in a container 3;

FIG. 3 is a diagram for describing a specific example of the processing in the container 3;

FIG. 4 is a diagram for describing a hardware configuration of a management device 1;

FIG. 5 is a functional block diagram of the management device 1;

FIG. 6 is a flowchart for describing an outline of application control processing according to a first embodiment;

FIG. 7 is a flowchart for describing details of the application control processing according to the first embodiment;

FIG. 8 is a flowchart for describing details of the application control processing according to the first embodiment;

FIG. 9 is a flowchart for describing details of the application control processing according to the first embodiment;

FIG. 10 is a flowchart for describing details of the application control processing according to the first embodiment;

FIG. 11 is a flowchart for describing details of the application control processing according to the first embodiment;

FIG. 12 is a flowchart for describing details of the application control processing according to the first embodiment;

FIG. 13 is a diagram for describing a specific example of application information 131;

FIG. 14 is a diagram for describing a specific example of application event information 132;

FIG. 15 is a diagram for describing a specific example of machine information 134;

FIG. 16 is a diagram for describing a specific example of flow information 133;

FIG. 17 is a diagram for describing details of the application control processing according to the first embodiment;

FIG. 18 is a diagram for describing details of the application control processing according to the first embodiment;

FIG. 19 is a diagram for describing a specific example of workflow information 135;

FIG. 20 is a diagram for describing details of the application control processing according to the first embodiment;

FIG. 21 is a diagram for describing a specific example of the workflow information 135;

FIG. 22 is a diagram for describing a specific example of the workflow information 135;

FIG. 23 is a diagram for describing a specific example of the workflow information 135;

FIG. 24 is a diagram for describing a specific example of the workflow information 135;

FIG. 25 is a diagram for describing a specific example of the flow information 133;

FIG. 26 is a diagram for describing a specific example of group information 136; and

FIG. 27 is a diagram for describing a specific example of the group information 136.

### DESCRIPTION OF EMBODIMENTS

For example, the business operator constructs the business system for providing the service to the user by linking applications that respectively operate in a plurality of containers generated in a physical machine. Then, the business operator, for example, provides a function as a service (FaaS) to the user by operating the constructed business system.

Here, in a case where the FaaS as described above is provided, for example, the business system sequentially activates a container in which an application for executing processing corresponding to a processing request operates in response to receipt of the processing request (hereinafter, also referred to as event) from the user. Furthermore, the business system stops the container, in which the application that has executed the processing operates, for example, in response to completion of the execution of the processing corresponding to the processing request. This makes it possible for the business operator to efficiently use resources of the physical machine where the container is generated.

However, for example, in a case where an application that executes processing next is determined according to the result of the processing of each application, the business system needs to activate a container in which the application that executes the processing next operates after waiting for the completion of the processing of each application. Therefore, with the business system, for example, there is a case where a response time to the processing request is lengthened depending on the number of applications that execute the processing corresponding the processing request.

Therefore, for example, the business system as described above activates in advance the container in which each application that can be determined to be highly likely to be executed after the running application operates. The business system refers to, for example, a past execution order of the respective applications and specifies an application having a high frequency of being executed after the running application. Then, the business system activates in advance the container in which the specified application operates. As a result, for example, even in a case where the number of applications that operate with the execution of the processing corresponding to the processing request is large, the business operator can shorten the response time to the processing request.

However, in the business system as described above, even if the container corresponding to the application that is highly likely to be executed after the running application is activated in advance, there is a possibility that an unstarted application is frequently executed after the running application. Therefore, the business system may not be able to shorten the response time to the processing request.

Therefore, in one aspect, an object of the embodiment is to provide an application control program and an application control method that can shorten a response time to a processing request.

### Configuration of Information Processing System

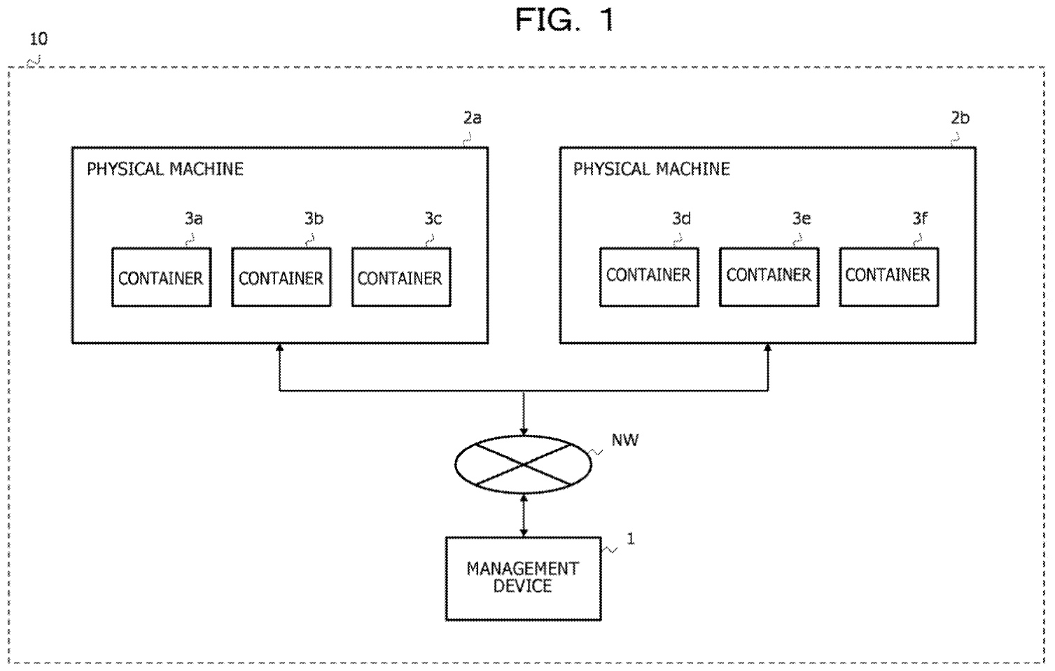

First, a configuration of an information processing system 10 will be described. FIG. 1 is a diagram for describing the configuration of the information processing system 10.

The information processing system 10 illustrated in FIG. 1 includes a management device 1 and physical machines 2a and 2b. In the physical machine 2a, containers 3a, 3b, and 3c operate, and in the physical machine 2b, containers 3d, 3e, and 3f operate. Hereinafter, the physical machines 2a and 2b are also collectively referred to as physical machine(s) 2, and the containers 3a, 3b, 3c, 3d, 3e, and 3f are also collectively referred to as container(s) 3. Note that, in the example illustrated in FIG. 1, the information processing system 10 includes the two physical machines 2. However, the number of physical machines 2 included in the information processing system 10 may be other than two. Furthermore, in the example illustrated in FIG. 1, the containers 3a, 3b, 3c, 3d, 3e, and 3f operate in the physical machine 2. However, the number of containers 3 that operate may be other than this, and in addition, the number of containers 3 that operate may be changed as needed.

Furthermore, for example, in a case of receiving a processing request transmitted by a user via a user terminal (not illustrated), the management device 1 specifies a container 3 in which an application that executes processing corresponding to the received processing request (hereinafter, simply referred to as application) operates. The user terminal (hereinafter, also referred to as a processing request source) is, for example, a terminal such as a personal computer (PC) or a smartphone in which the user inputs necessary information. Furthermore, the user terminal is, for example, one of various sensors installed in a factory. Then, the management device 1, for example, activates the specified container 3, and in addition, transmits the processing request received from the user terminal to the activated container 3. Hereinafter, a specific example of the processing in the container 3 will be described.

### Specific Example of Processing in Container

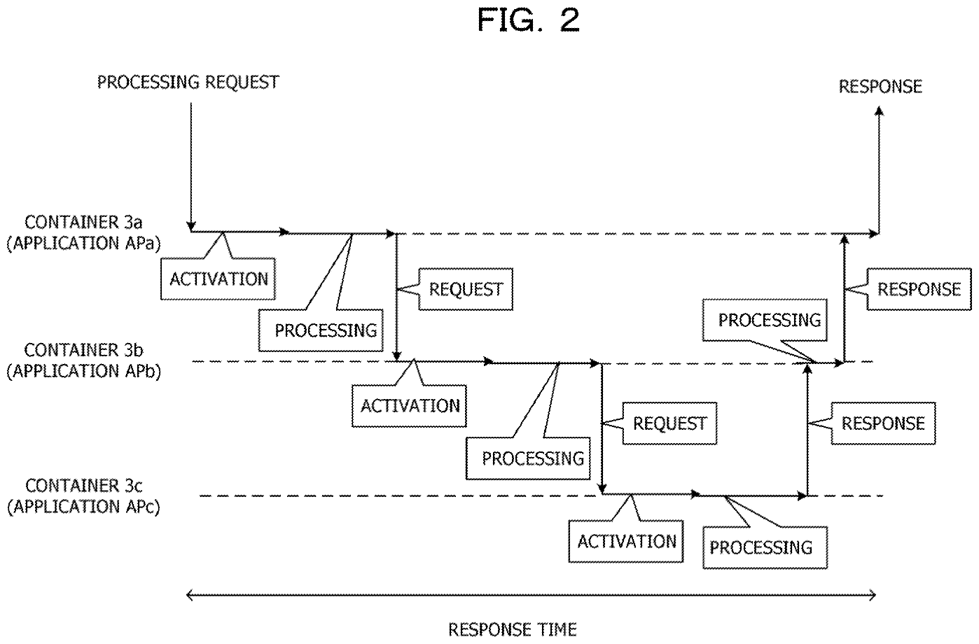

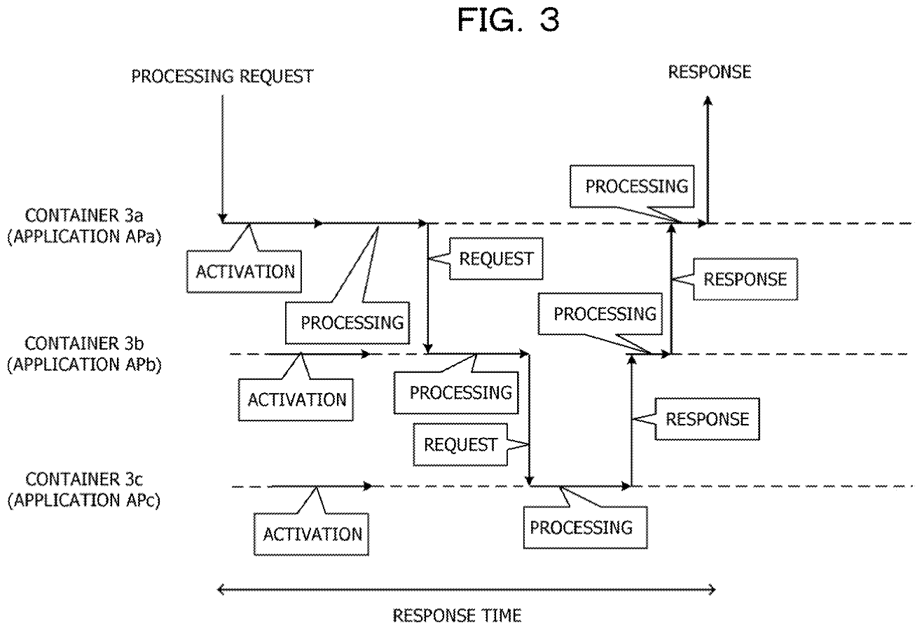

FIGS. 2 and 3 are diagrams for describing specific examples of the processing in the container 3. Hereinafter, description will be made as assuming that applications APa, APb, and APc respectively operate in the containers 3a, 3b, and 3c. Furthermore, hereinafter, the applications APa, APb, and APc are also collectively referred to as an application AP.

For example, in a case of receiving a processing request that requires the application APa to operate first, as illustrated in FIG. 2, for example, the management device 1 instructs the physical machine 2a that stores an image file (not illustrated) of the container 3a that executes the application APa to activate the container 3a. Then, the management device 1 transmits the received processing request to the container 3a in response to completion of the activation of the container 3a.

Subsequently, the application APa executes processing according to the processing request received from the management device 1 in the container 3a. Then, for example, in a case where the application APb is specified as an application AP to execute processing next as a result of completing the execution of the processing according to the received processing request, for example, the management device 1 instructs the physical machine 2a that stores an image file of the container 3b that executes the application APb to activate the container 3b. Moreover, the container 3a transmits, to the container 3b, a processing request that is generated along with the completion of the processing by the application APa.

Next, the application APb executes processing according to the processing request received from the container 3a in the container 3b. Then, for example, in a case where the application APc is specified as an application to execute processing next as a result of completing the execution of the processing according to the received processing request, for example, the management device 1 instructs the physical machine 2a that stores an image file of the container 3c that executes the application APc to activate the container 3c. Moreover, the container 3b transmits, to the container 3c, a processing request that is generated along with the completion of the processing by the application APb.

Subsequently, the application APc executes processing according to the processing request received from the container 3b in the container 3c. Then, for example, in a case where it is determined that no application to execute processing next exists as a result of completing the execution of the processing according to the received processing request, the container 3c, for example, transmits a processing result (response) by the application APc to the container 3b.

Thereafter, the application APb executes necessary processing, for example, on the processing result received from the container 3c. Then, the container 3b transmits a processing result obtained by executing the necessary processing by the application APb to the container 3a.

Moreover, the application APa, for example, executes necessary processing on the processing result received from the container 3b. Then, the container 3a transmits the processing result obtained by executing the necessary processing by the application APa to the user terminal or the like that has transmitted the processing request to the management device 1.

Here, in a case of the example in FIG. 2, the information processing system 10 sequentially activates the container 3 in which the application AP that executes processing next operates after the processing executed by each application AP is completed. Generally, a time required to execute the application AP is about several (ms). On the other hand, a time required for activation of the container 3 is about 300 (ms) to several (seconds). Therefore, there is a case where the information processing system 10 takes a longer response time to the user who has transmitted a processing request.

Therefore, for example, the information processing system 10 activates in advance the container 3 in which each application AP that is highly likely to be executed after the running application AP operates. For example, as illustrated in FIG. 3, the information processing system 10 activates, in advance, the containers 3b and 3c in which the respective applications APb and APc that can be determined to be highly likely to be executed after the application APa operate before the execution of the processing by the application APa ends. The information processing system 10 refers to, for example, a past execution order of the respective applications AP, and specifies the application APb and the application APc respectively as the applications AP having a high frequency of being executed after the running application AP. Then, for example, the information processing system 10 activates in advance the container 3b and the container 3c in which the specified application APb and application APc respectively operate. As a result, for example, as illustrated in FIG. 3, a business operator can suppress the response time to the processing request.

However, as illustrated in FIG. 3, even in the case where the containers 3 in which each of the applications AP that are highly likely to be executed after the running application AP operate are activated in advance, for example, there is a possibility that an unstarted application AP (an application AP determined to be less likely to be executed after the running application AP, for example) is frequently executed after the running application AP. Therefore, the information processing system 10 may not be able to shorten the response time to the processing request.

Therefore, in a case where a specific application AP included in a plurality of applications AP is executed in response to a processing request from a specific processing request source, the management device 1 refers to a storage unit (not illustrated) that stores flow information indicating the past execution order of the plurality of applications AP for each processing request source of the plurality of applications AP. Then, the management device 1 calculates an execution probability that each of one or more applications AP that are likely to be executed after the specific application AP is executed after the specific application AP executed in response to the processing request from the specific processing request source. Thereafter, the management device 1 specifies an application AP to be activated on the basis of the calculated execution probability, and activates the specified application AP to be activated.

For example, the management device 1 according to the present embodiment specifies the application AP that is highly likely to be executed after the specific application AP on the basis of a past record of the execution order of the respective applications AP in a case where the processing request from the specific processing request source has been made in the past. Then, the management device 1 only activates the specified application AP in advance.

Thereby, the management device 1 in the present embodiment can predict with higher accuracy the application AP that is highly likely to be executed after the specific application AP. Therefore, the management device 1 can suppress the probability that the unstarted application AP is executed at the time of executing each application AP with the reception of the processing request. Therefore, the management device 1 can suppress the probability that the application AP is activated at the time of executing each application AP with the reception of the processing request, and can shorten the response time to the processing request.

### Hardware Configuration of Information Processing System

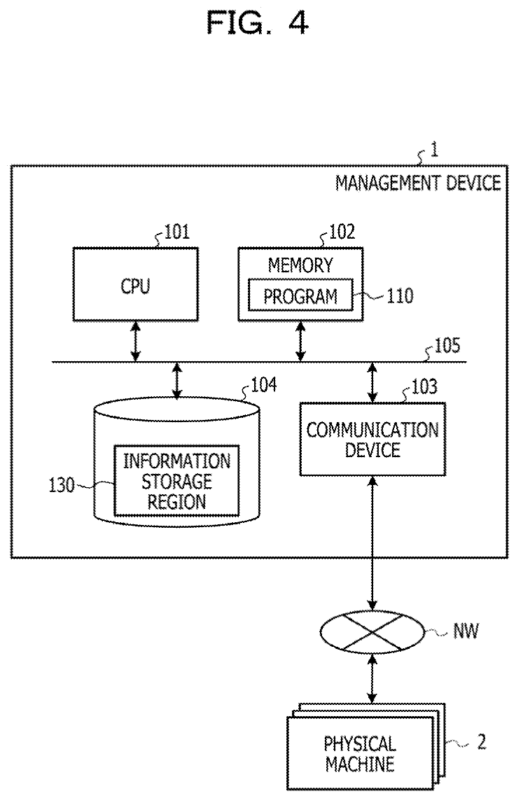

Next, a hardware configuration of the information processing system 10 will be described. FIG. 4 is a diagram for describing a hardware configuration of the management device 1.

As illustrated in FIG. 4, the management device 1 includes a central processing unit (CPU) 101 that is a processor, a memory 102, a communication device 103, and a storage medium 104. The respective units are interconnected with one another via a bus 105.

The storage medium 104 has, for example, a program storage region (not illustrated) in which a program 110 that executes processing for controlling an activation timing or the like of each application AP (hereinafter, also referred to as application control processing) is stored. Furthermore, the storage medium 104 includes, for example, a storage unit 130 (hereinafter, also referred to as information storage region 130) for storing information to be used when the application control processing is executed. Note that the storage medium 104 may be, for example, a hard disk drive (HDD) or a solid state drive (SSD).

The CPU 101 executes the program 110 that is loaded from the storage medium 104 into the memory 102 so as to execute the application control processing.

Furthermore, the communication device 103 communicates with each physical machine 2, for example, via a network NW.

### Functions of Information Processing System

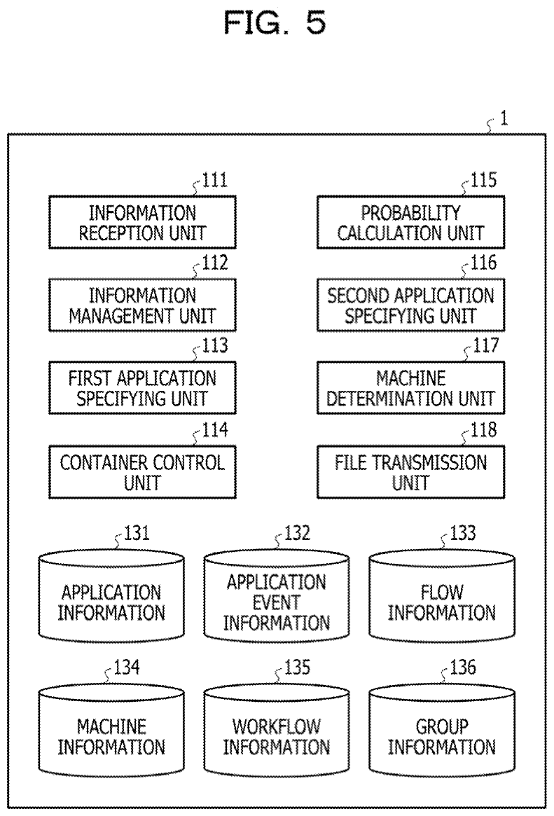

Next, functions of the information processing system 10 will be described. FIG. 5 is a functional block diagram of the management device 1.

As illustrated in FIG. 5, the management device 1 achieves various functions including an information reception unit 111, an information management unit 112, a first application specifying unit 113, a container control unit 114 (hereinafter, also referred to as activation control unit 114), a probability calculation unit 115, a second application specifying unit 116 (hereinafter, also referred to as target specifying unit 116), a machine determination unit 117, and a file transmission unit 118, for example, by organically linking hardware such as the CPU 101 or the memory 102 and the program 110.

Furthermore, for example, as illustrated in FIG. 5, the management device 1 stores application information 131, application event information 132, flow information 133, machine information 134, workflow information 135, and group information 136 in the information storage region 130.

The information reception unit 111 receives, for example, the application information 131 and the application event information 132 transmitted by a business operator via a business operator terminal (not illustrated). The application information 131 is information regarding an application AP executed in each container 3. Furthermore, the application event information 132 is information indicating a correspondence relationship between a processing request (event) transmitted from the user and an application AP that executes processing according to each processing request.

Furthermore, the information reception unit 111 receives, for example, the processing request transmitted by the user via the user terminal.

The information management unit 112 stores the application information 131 and the application event information 132 received by the information reception unit 111 in the information storage region 130.

Furthermore, the information management unit 112 generates the flow information 133 that indicates an execution order of each application AP executed in response to receipt of the processing request by the information reception unit 111.

The information management unit 112 classifies, for example, by attributes of the user terminals that have transmitted the processing request received by the information reception unit 111 into a plurality of groups. Then, the information management unit 112 generates, for example, the flow information 133 for each of the plurality of classified groups. Examples of the attributes of the user terminal include an internet protocol (IP) address and a subnet corresponding to the user terminal. Furthermore, the attribute of the user terminal is, for example, a type of the user terminal (device type). Then, the information management unit 112 stores the generated flow information 133 in the information storage region 130.

The first application specifying unit 113 refers to the application event information 132 stored in the information storage region 130 and specifies an application AP that needs to be executed in response to the receipt of the processing request received by the information reception unit 111.

The container control unit 114 activates the container 3 in which the application AP specified by the first application specifying unit 113 is executed. Then, the container control unit 114 executes the application AP specified by the first application specifying unit 113 in the activated container 3.

In the case where the application AP specified by the first application specifying unit 113 is executed, the probability calculation unit 115 refers to the flow information 133 corresponding to the attribute of the user terminal as the transmission source of the processing request received by the information reception unit 111, among the flow information 133 stored in the information storage region 130, and specifies the applications AP that are likely to be executed after the running application AP. Then, the probability calculation unit 115 calculates the execution probability that each of the specified applications AP is executed after the running application AP.

The second application specifying unit 116 specifies an application AP to be activated in advance on the basis of the execution probability calculated by the probability calculation unit 115.

Furthermore, the second application specifying unit 116 specifies an application AP that stores an image file required to execute each application AP in the physical machine 2 that executes each application AP (image file used to activate container 3 that executes each application AP) in advance on the basis of the execution probability calculated by the probability calculation unit 115.

The machine determination unit 117 determines the physical machine 2 that executes each application AP specified by the second application specifying unit 116 on the basis of the machine information 134 stored in the information storage region 130, for example. The machine information 134 is information including a usage rate of a CPU of each physical machine 2 and a free space of the memory and, for example, is information transmitted from each physical machine 2 as needed.

For example, the file transmission unit 118 transmits each image file required to execute each application AP specified by the second application specifying unit 116 to the physical machine 2 that executes each application AP (physical machine 2 determined by machine determination unit 117). Note that the image file required to execute each application AP may be, for example, stored in the information storage region 130. Then, for example, the file transmission unit 118 may transmit each image file required to execute each application AP specified by the second application specifying unit 116 among the image files stored in the information storage region 130 to the physical machine 2 that executes each application AP.

Note that, for example, in a case where there is a plurality of services to be provided to the user, the information management unit 112 may generate the flow information 133 for each service. Then, in this case, the probability calculation unit 115 may refer to the flow information 133 corresponding to the attribute of the user terminal among the flow information 133 corresponding to the services to be provided to the user terminal as the transmission source of the processing request received by the information reception unit 111, for example. The workflow information 135 and the group information 136 will be described below.

### Outline of First Embodiment

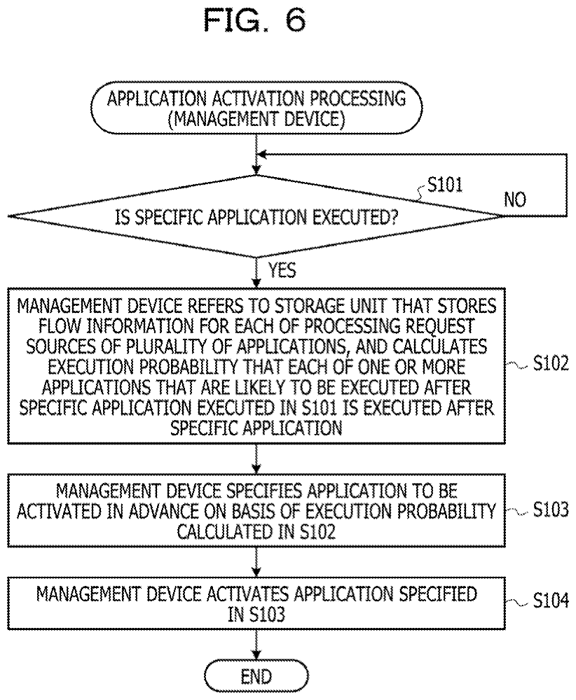

Next, an outline of a first embodiment will be described. FIG. 6 is a flowchart for describing an outline of the application control processing according to the first embodiment.

As illustrated in FIG. 6, the management device 1 waits until the specific application AP is executed in response to the processing request from the specific processing request source (NO in S101).

Then, in the case where the specific application AP is executed in response to the processing request from the specific processing request source (YES in S101), the management device 1 refers to the information storage region 130 that stores the flow information 133 indicating the past execution order of a plurality of applications AP for each processing request source of the plurality of applications, and calculates the execution probability that each of one or more applications AP that are likely to be executed after the specific application AP executed in response to the processing request from the specific processing request source, among the plurality of applications, is executed after the specific application AP executed in response to the processing request from the specific processing request source (S102).

Subsequently, the management device 1 specifies an application AP to be activated in advance on the basis of the execution probability calculated in the processing in S102 (S103).

The management device 1 specifies, for example, an application AP in which the execution probability calculated in the processing in S102 is equal to or larger than a predetermined threshold (hereinafter, also referred to as a first threshold) as an application AP to be activated in advance.

Thereafter, the management device 1 activates the application AP specified in the processing in S103 (S104).

Thereby, the management device 1 in the present embodiment can predict with higher accuracy the application AP that is likely to be executed after the specific application AP, for example. Therefore, the management device 1 can suppress the probability that the unstarted application AP is executed at the time of executing each application AP with the reception of the processing request, for example. Therefore, the management device 1 can suppress the probability that the application AP is activated at the time of executing each application AP with the reception of the processing request, and can shorten the response time to the processing request, for example.

### Details of First Embodiment

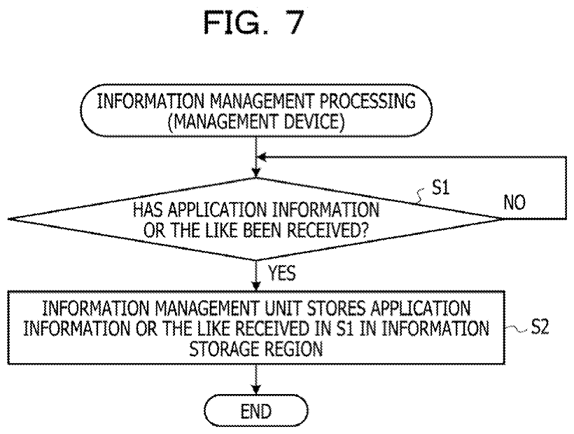

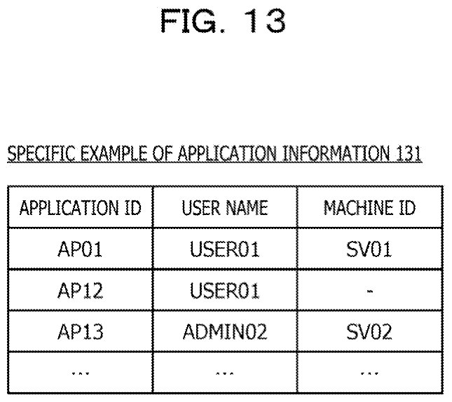

Next, details of the first embodiment will be described. FIGS. 7 to 12 are flowcharts for describing details of the application control processing according to the first embodiment. Furthermore, FIGS. 13 to 27 are diagrams for describing details of the application control processing according to the first embodiment.

### Information Management Processing

First, processing for managing the application information 131 and the application event information 132 (hereinafter, also referred to as information management processing) in the application control processing will be described. FIG. 7 is a flowchart for describing the information management processing.

As illustrated in FIG. 7, the information reception unit 111 of the management device 1 waits, for example, until the application information 131 or the application event information 132 is received from a business operator terminal (not illustrated) (NO in S1).

Then, in a case where the application information 131 or the application event information 132 is received (YES in S1), the information management unit 112 stores the application information 131 or the application event information 132 received in the processing in S1 in the information storage region 130 (S2). Hereinafter, specific examples of the application information 131 and the application event information 132 will be described.

### Specific Example of Application Information

First, the specific example of the application information 131 will be described. FIG. 13 is a diagram for describing the specific example of the application information 131.

The application information 131 illustrated in FIG. 13 includes, as items, an “application Identifier (ID)” used to identify each application AP, a “user's name” used to identify the user who uses each application AP, and a “machine ID” used to identify a physical machine 2 that stores an image file (not illustrated) required to execute each application AP.

For example, in the application information 131 illustrated in FIG. 13, with respect to information in the first row, “AP01” is set as the “application ID”, “USER01” is set as the “user's name”, and “SV01” is set as the “machine ID”.

Furthermore, in the application information 131 illustrated in FIG. 13, with respect to information in the second row, “AP02” is set as the “application ID”, “USER01” is set as the “user's name”, and “−” indicating that no physical machine 2 that stores an image file exists is set as the “machine ID”. The description of other information included in FIG. 13 will be omitted.

### Specific Example of Application Event Information

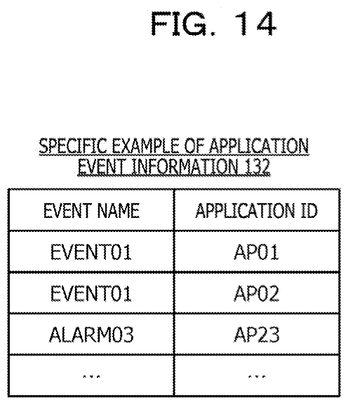

Next, the specific example of the application event information 132 will be described. FIG. 14 is a diagram for describing the specific example of the application event information 132.

The application event information 132 illustrated in FIG. 14 includes, as items, an “event name” used to identify each processing request transmitted from the user terminal and an “application ID” used to identify each application AP.

For example, in the application event information 132 illustrated in FIG. 14, with respect to information in the first row, “EVENT01” is set as the “event name”, and “AP01” is set as the “application ID”.

Furthermore, in the application event information 132 illustrated in FIG. 14, with respect to information in the second row, “EVENT02” is set as the “event name”, and “AP02” is set as the “application ID”. The description of other information included in FIG. 14 will be omitted.

### Main Processing of Application Control Processing

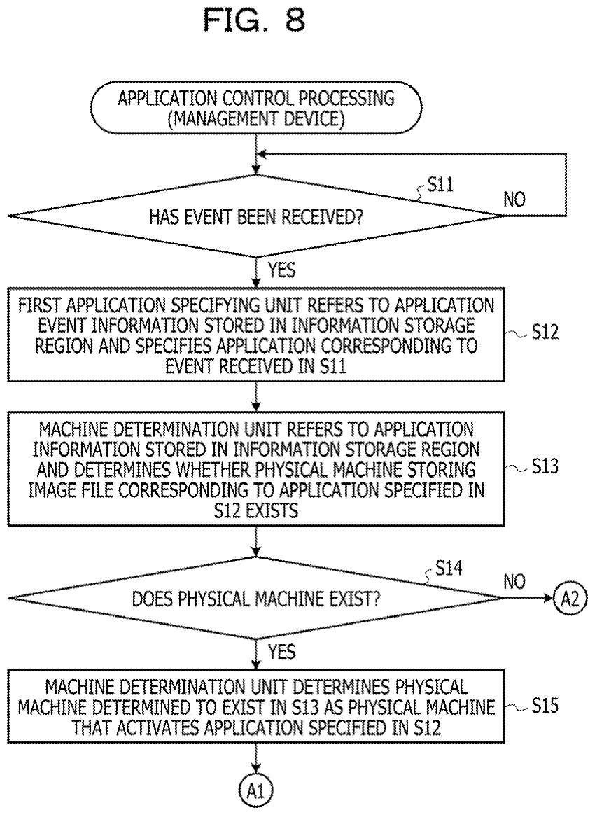

Next, main processing of the application control processing will be described. FIGS. 8 to 11 are flowcharts for describing the main processing of the application control processing.

As illustrated in FIG. 8, the information reception unit 111 waits, for example, until a processing request is received from the user terminal (NO in S11).

Then, in a case where the processing request is received (YES in S11), the first application specifying unit 113 of the management device 1 refers to the application event information 132 stored in the information storage region 130 and specifies an application AP corresponding to the processing request received in the processing in S11 (S12).

Specifically, for example, in the application event information 132 illustrated in FIG. 14, with respect to information to which “EVENT01” is set (information in first row) as the “event name”, “AP01” is set as the “application ID”. Therefore, for example, in a case where an “event name” of an event corresponding to the processing request received in the processing in S11 is “EVENT01”, the first application specifying unit 113 specifies an application AP of which the “application ID” is “AP01”.

Subsequently, the machine determination unit 117 of the management device 1 refers to the application information 131 stored in the information storage region 130 and determines whether or not a physical machine 2 that stores an image file corresponding to the application AP specified in the processing in S12 exists (S13).

For example, in the application information 131 illustrated in FIG. 13, with respect to information of which the “application ID” is “AP01” (information in first row), “SV01” is set as the “machine ID”. Therefore, for example, in a case where the “application ID” of the application AP specified in the processing in S12 is “AP01”, the machine determination unit 117 specifies a physical machine 2 of which the “machine ID” is “SV01” as the physical machine 2 that stores the image file corresponding to the application AP specified in the processing in S12.

Then, in a case where it is determined that the physical machine 2 exists (YES in S14), the machine determination unit 117 determines the physical machine 2 that is determined to exist in the processing in S13 as the physical machine 2 that activates the application AP specified in the processing in S12 (S15).

For example, the machine determination unit 117 determines the physical machine 2 that stores the image file required to execute each application AP as the physical machine 2 that activates the application AP specified in the processing in S12.

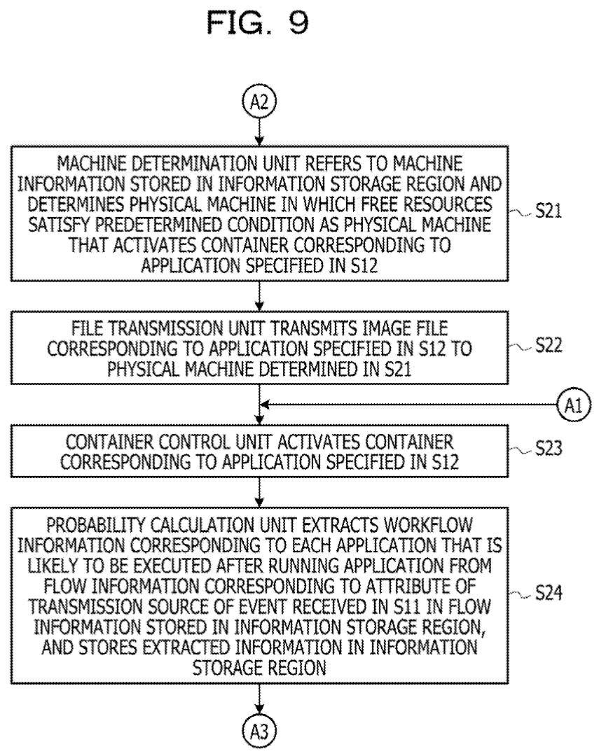

On the other hand, in a case where the physical machine 2 is determined not to exist (NO in S14), the machine determination unit 117, as illustrated in FIG. 9, refers to the machine information 134 stored in the information storage region 130 and determines any one of physical machines 2 in which free resources satisfy a predetermined condition as the physical machine 2 that activates the container 3 corresponding to the application AP specified in the processing in S12 (S21).

The machine determination unit 117 determines, for example, a physical machine 2 of which a usage rate of a CPU is equal to or less than a threshold (hereinafter, also referred to as CPU threshold) and a free space of a memory is equal to or larger than a threshold (hereinafter, also referred to as memory threshold) as the physical machine 2 that activates the container 3 corresponding to the application AP specified in the processing in S12. Hereinafter, a specific example of the machine information 134 will be described.

### Specific Example of Machine Information

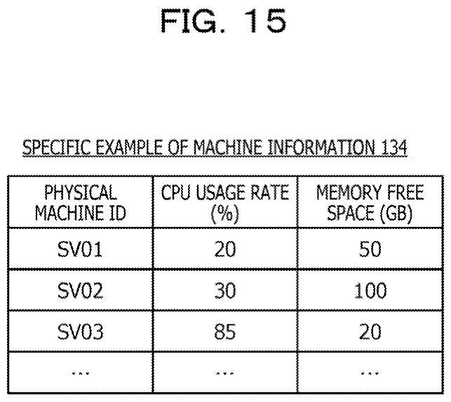

FIG. 15 is a diagram for describing the specific example of the machine information 134.

The machine information 134 illustrated in FIG. 15 includes, as items, a “physical machine ID” used to identify each physical machine 2, a “CPU usage rate” to which the usage rate of the CPU of each physical machine 2 is set, and a “memory free space” to which the free space of the memory of each physical machine 2 is set.

In the machine information 134 illustrated in FIG. 15, with respect to information in the first row, “SV01” is set as the “physical machine ID”, “20(%)” is set as the “CPU usage rate”, and “50 gigabyte (GB)” is set as the “memory free space”, for example.

Furthermore, in the machine information 134 illustrated in FIG. 15, with respect to information in the second row, “SV02” is set as the “physical machine ID”, “30(%)” is set as the “CPU usage rate”, and “100 (GB)” is set as the “memory free space”. The description of other information included in FIG. 15 will be omitted.

Therefore, for example, in a case where the CPU threshold is 50(%) and the memory threshold is 50 (GB), the machine determination unit 117 determines a physical machine 2 of which the value set to the “CPU usage rate” is equal to or less than 50(%) and the value set to the “memory free space” is equal to or larger than 50 (GB) (for example, physical machine 2 of which “physical machine ID” is “SV02”) as the physical machine 2 that activates the container 3 corresponding to the application AP specified in the processing in S12.

Returning to FIG. 9, the file transmission unit 118 of the management device 1 transmits the image file required to execute the application AP specified in the processing in S12 to the physical machine 2 determined in the processing in S21 (S22).

Then, the container control unit 114 activates the container 3 corresponding to the application AP specified in the processing in S12 in the physical machine 2 determined in the processing in S15 or S21, and further executes the application AP specified in the processing in S12 in the activated container 3 (S23).

Note that, in a case of determining that the physical machine 2 that stores the image file required to execute the application AP specified in the processing in S12 exists (YES in S14), the management device 1 may determine whether or not free resources of the physical machine 2 satisfy a predetermined condition (predetermined condition in processing in S21). Then, in a case of determining that the free resources do not satisfy the predetermined condition, the management device 1 may execute the processing in S21 and S22.

Subsequently, the probability calculation unit 115 of the management device 1 extracts information (hereinafter, also referred to as workflow information 135) corresponding to each application AP that is likely to be executed after the running application AP (application AP specified in processing in S12) from information included in the flow information 133 corresponding to the attribute of the user terminal as the transmission source that has transmitted the processing request received in the processing in S11 among the flow information 133 stored in the information storage region 130, and stores the extracted information in the information storage region 130 (S24). Hereinafter, a specific example of the flow information 133 will be described.

### Specific Example of Flow Information

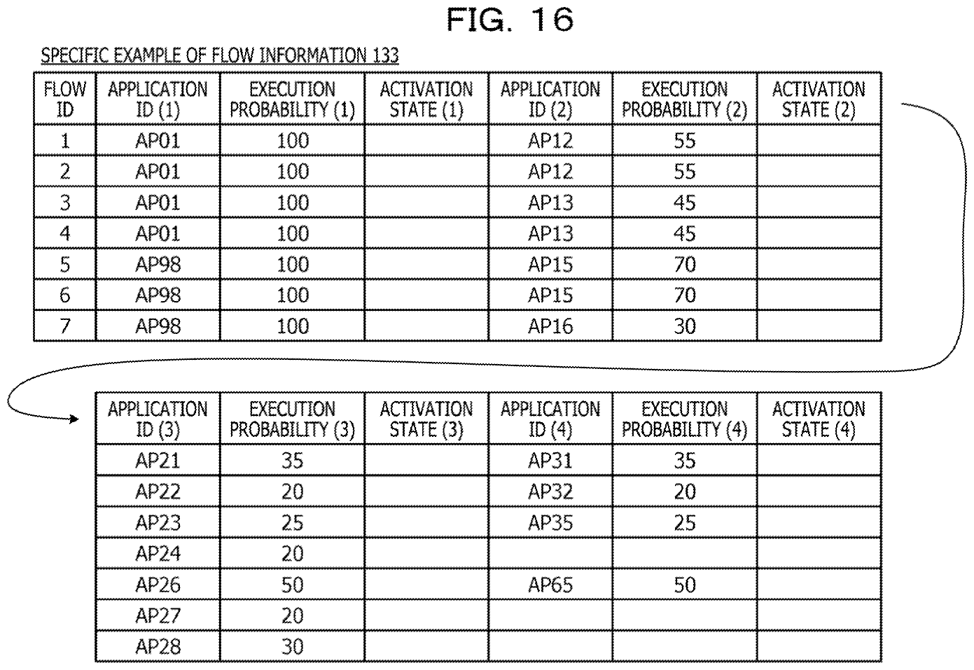

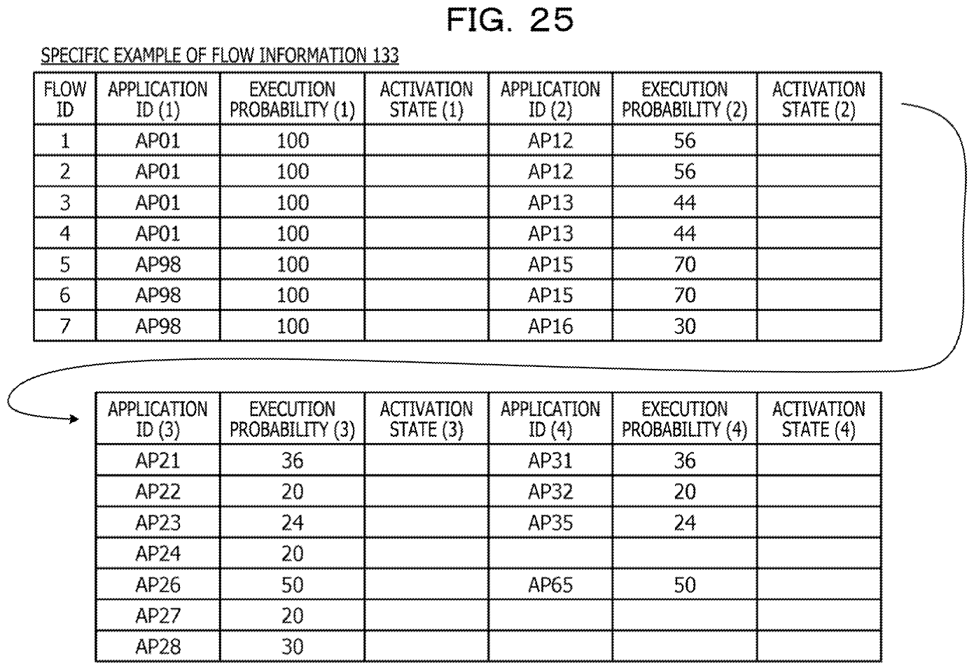

FIGS. 16 and 25 are diagrams for describing specific examples of the flow information 133. FIG. 16 and the like are diagrams for describing a specific example of the flow information 133 corresponding to a specific attribute among the flow information 133 stored in the information storage region 130, for example.

The flow information 133 illustrated in FIG. 16 or the like includes, as items, a “flow ID” used to identify an execution order of each application AP (hereinafter, also referred to as flow), an “application ID” used to identify each application AP, an “execution probability” indicating a probability such that each application AP is executed, and an “activation state” indicating an activation state of the container 3 in which each application AP is executed. Note that, in the flow information 133 illustrated in FIG. 16 or the like, the “application ID” corresponding to four applications AP at the maximum included in each flow, the “execution probability”, and the “activation state” are set.

For example, in the flow information 133 illustrated in FIG. 16, with respect to information in the first row to information in the fourth row, “1” to “4” are respectively set as the “flow IDs”, “AP01” is set as the “application ID (1)”, and “100(%)” is set as the “execution probability (1)”.

Then, in the flow information 133 illustrated in FIG. 16, with respect to the information in the first and second rows, “AP12” is set as the “application ID (2)”, and “55(%)” is set as the “execution probability (2)”. Furthermore, in the flow information 133 illustrated in FIG. 16, with respect to the information in the third and fourth rows, “AP13” is set as the “application ID (2)”, and “45(%)” is set as the “execution probability (2)”.

Moreover, in the flow information 133 illustrated in FIG. 16, with respect to the information in the first row, “AP21” is set as the “application ID (3)”, “35(%)” is set as the “execution probability (3)”, “AP31” is set as the “application ID (4)”, and “35(%)” is set as the “execution probability (4)”. Furthermore, in the flow information 133 illustrated in FIG. 16, with respect to the information in the second row, “AP22” is set as the “application ID (3)”, “20(%)” is set as the “execution probability (3)”, “AP32” is set as the “application ID (4)”, and “20(%)” is set as the “execution probability (4)”. Furthermore, in the flow information 133 illustrated in FIG. 16, with respect to the information in the third row, “AP23” is set as the “application ID (3)”, “25(%)” is set as the “execution probability (3)”, “AP35” is set as the “application ID (4)”, and “25(%)” is set as the “execution probability (4)”.

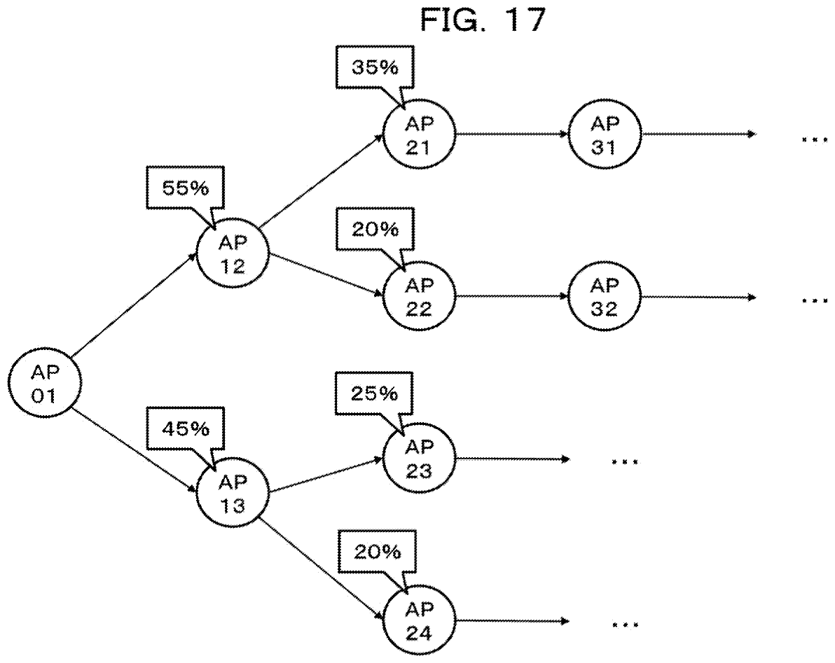

For example, the flow information 133 illustrated in FIG. 16 indicates that, as illustrated in FIG. 17, in a case where an application AP of which the “application ID” is “AP01” is executed in a predetermined period in the past (for example, a week immediately before), an application AP of which the “application ID” is “AP12” is executed with the probability of 55(%) and the application AP of which an “application ID” is “AP13” is executed with the probability of 45(%) immediately after the execution of the above application AP.

Furthermore, the flow information 133 illustrated in FIG. 16 indicates that, as illustrated in FIG. 17, in a case where the application AP of which the “application ID” is “AP01” is executed, immediately after the execution of the application AP of which the “application ID” is “AP12”, an application AP of which the “application ID” is “AP21” is executed with the probability of 35(%), and an application AP of which the “application ID” is “AP22” is executed with the probability of 20(%).

Furthermore, the flow information 133 illustrated in FIG. 16 indicates that, as illustrated in FIG. 17, in a case where the application AP of which the “application ID” is “AP01” is executed, immediately after the execution of the application AP of which the “application ID” is “AP13”, an application AP of which the “application ID” is “AP23” is executed with the probability of 25(%), and an application AP of which the “application ID” is “AP24” is executed with the probability of 20(%).

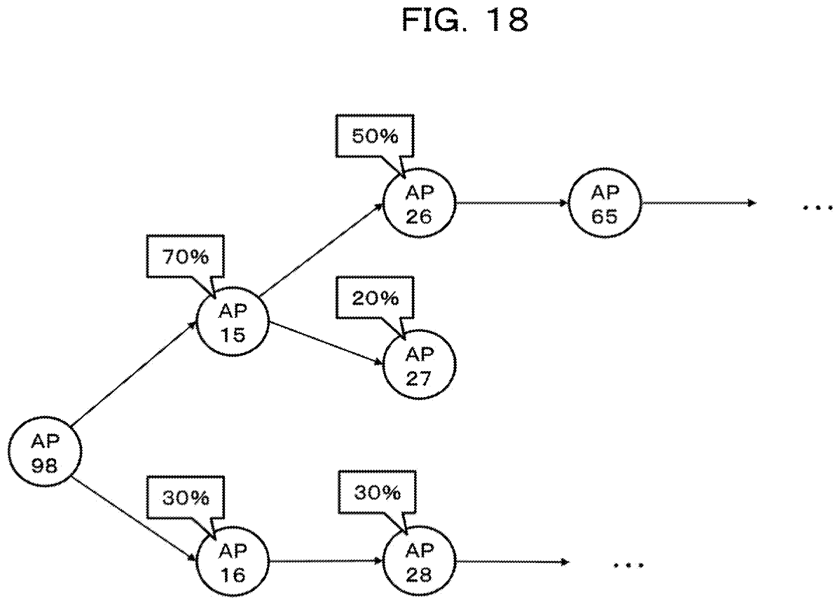

Similarly, the flow information 133 illustrated in FIG. 16 indicates that, as illustrated in FIG. 18, in a case where an application AP of which the “application ID” is “AP98” is executed in a predetermined period in the past (for example, a week immediately before), immediately after the execution of the above application AP, an application AP of which the “application ID” is “AP15” is executed with the probability of 70(%) and an application AP of which the “application ID” is “AP16” is executed with the probability of 30(%).

Furthermore, the flow information 133 illustrated in FIG. 16 indicates that, as illustrated in FIG. 18, in a case where the application AP of which the “application ID” is “AP98” is executed, immediately after the execution of the application AP of which the “application ID” is “AP15”, an application AP of which the “application ID” is “AP26” is executed with the probability of 50(%), and an application AP of which the “application ID” is “AP27” is executed with the probability of 20(%).

Furthermore, the flow information 133 illustrated in FIG. 16 indicates that, as illustrated in FIG. 18, in a case where the application AP of which the “application ID” is “AP98” is executed, immediately after the execution of the application AP of which the “application ID” is “AP16”, an application AP of which the “application ID” is “AP28” is executed with the probability of 30(%).

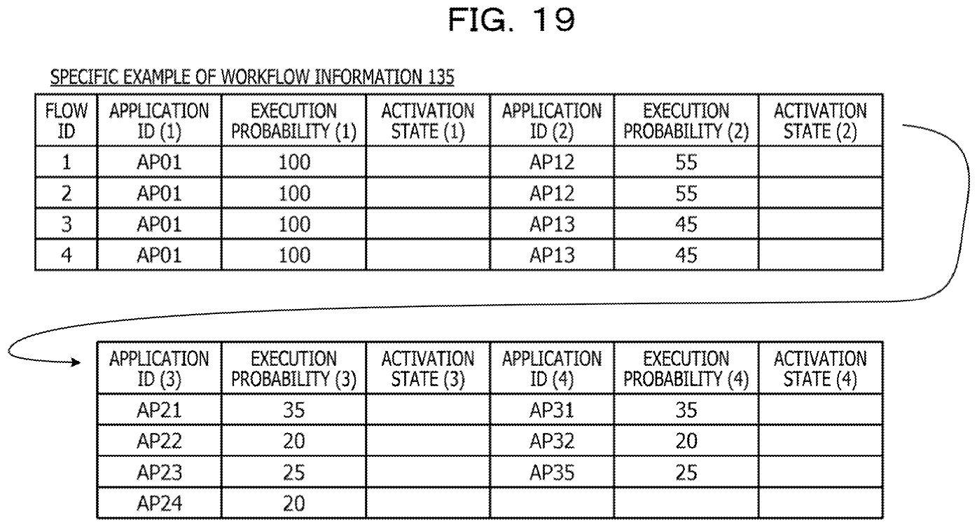

Therefore, for example, the flow information 133 corresponding to the attribute of the transmission source of an event received in the processing in S11 is the flow information 133 illustrated in FIG. 16, and in a case where the execution of the application AP of which the “application ID” is “AP01” is started, as illustrated in FIG. 19, the probability calculation unit 115 extracts, in the processing in S24, information corresponding to the application AP of which the “application ID” is “AP01” (information in first row to fourth row) from the information included in the flow information 133 illustrated in FIG. 16 as the workflow information 135.

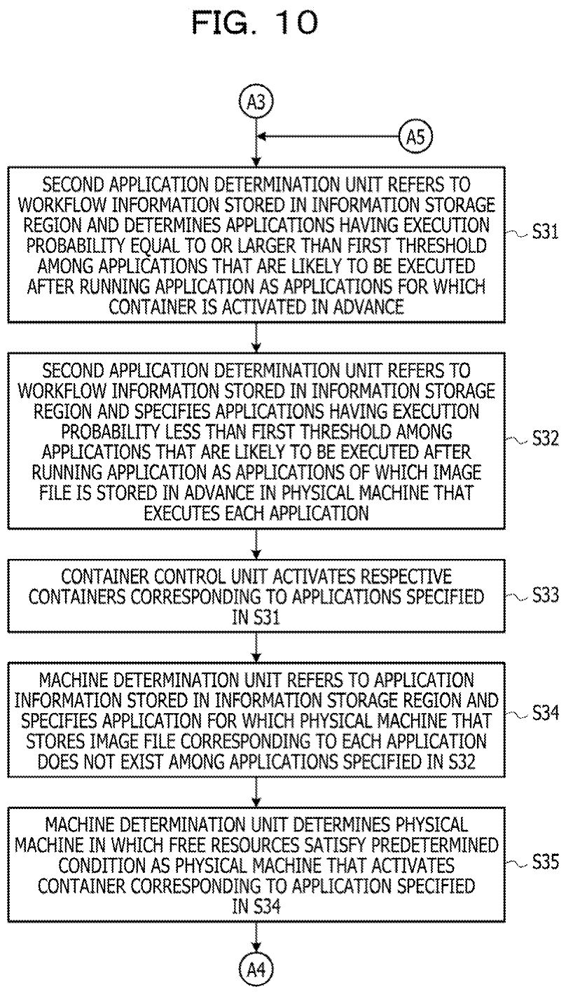

Returning to FIG. 10, the second application specifying unit 116 of the management device 1 refers to the workflow information 135 stored in the information storage region 130 and specifies an application AP of which an execution probability is equal to or larger than the first threshold among the applications AP that are likely to be executed after the running application AP as the application AP for which the container 3 is activated in advance (S31).

Furthermore, the second application specifying unit 116 refers to the workflow information 135 stored in the information storage region 130 and specifies an application AP of which an execution probability is less than the first threshold among the applications AP that are likely to be executed after the running application AP as the application AP of which the image file is stored in advance in the physical machine 2 that executes each application AP (S32).

For example, the second application specifying unit 116 refers to the workflow information 135 stored in the information storage region 130 and specifies each application AP of which the number of applications AP executed before the execution of each application AP, after the execution of the running application AP is equal to or less than a predetermined number (for example, equal to or less than two). Then, the second application specifying unit 116 specifies the application AP of which the execution probability is equal to or larger than the first threshold, among the specified applications AP, as the application AP that activates the container 3 for executing each application AP in advance.

Furthermore, the second application specifying unit 116 specifies the application AP of which the execution probability is less than the first threshold among the specified applications AP as the application AP of which the image file is stored in advance in the physical machine 2 that executes each application AP (application AP for which the container 3 is not activated in advance).

In the flow information 133 illustrated in FIG. 19, for example, applications AP of which the number of applications AP to be executed before the execution of each application AP, after the execution of the application AP of which the “application ID” is “AP01” is equal to or less than two are the applications AP each having the “application IDs” of “AP12”, “AP13”, “AP21”, “AP22”, “AP23”, and “AP24”. Then, in the flow information 133 illustrated in FIG. 19, “execution probabilities” of the applications AP having the “application IDs” of “AP12”, “AP13”, “AP21”, “AP22”, “AP23”, and “AP24” are respectively “55(%)”, “45(%)”, “35(%)”, “20(%), “25(%)”, and “20(%)”.

Therefore, for example, in a case where the first threshold is equal to or larger than 35(%), the second application specifying unit 116 specifies “AP12”, “AP13”, and “AP21” that are the “application IDs” of the applications AP of which the “execution probability” is equal to or larger than “35(%)” in the processing in S31.

Furthermore, the second application specifying unit 116 specifies “AP22”, “AP23”, and “AP24” that are the “application IDs” of the applications AP of which the “execution probability” is less than “35(%)” in the processing in S32 in this case.

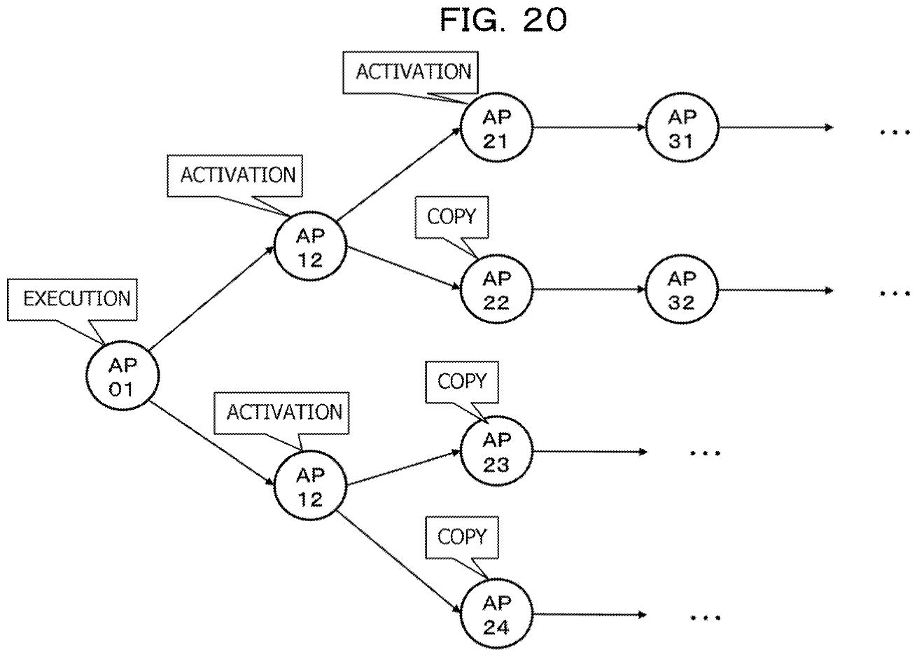

For example, as illustrated in FIG. 20, the second application specifying unit 116 determines “AP12”, “AP13”, and “AP21” that are the “application IDs” of the applications AP of which the “execution probability” is equal to or larger than “35(%)” as applications AP that are highly likely to be executed after the running application AP and specifies the determined applications AP as applications AP for which the container 3 that executes each application AP is activated in advance.

Furthermore, the second application specifying unit 116 determines “AP22”, “AP23”, and “AP24” that are the “application IDs” of the applications AP of which the “execution probability” is less than “35(%)” as applications AP that are less likely to be executed after the running application AP and specifies the determined applications AP as the applications AP for which the image file is stored (copies) in advance in the physical machine 2 that executes each application AP.

As a result, the management device 1 becomes able to activate, in advance, only the container 3 corresponding to the application AP that can be determined to be highly likely to be executed after the running application AP. Therefore, the management device 1 can suppress the frequency of activating the container 3 at the time of starting the execution of each application AP and can suppress the response time to the processing request while suppressing the consumption of the physical resource of the physical machine 2.

Furthermore, the management device 1 can store in advance the image file of the application AP that can be determined to be likely to be executed after the running application AP in the physical machine 2 in which each application AP is executed. Therefore, the management device 1 can suppress the frequency of transmitting and receiving the image file and the like at the time of starting the execution of each application AP and can suppress the response time to the processing request.

Returning to FIG. 10, the container control unit 114 activates each container 3 corresponding to the application AP specified in the processing in S31 (S33).

Note that the container control unit 114 may activate only the container 3 of which an activation time in the past (for example, average of activation time in the past) is equal to or larger than a predetermined threshold, for example, among the containers 3 corresponding to the applications AP specified in the processing in S31.

Then, the machine determination unit 117 refers to the application information 131 stored in the information storage region 130 and specifies the application AP for which the physical machine 2 that stores the image file required to execute each application AP does not exist from among the applications AP specified in the processing in S32 (S34).

For example, the machine determination unit 117 specifies the application AP that needs to transmit the image file to any one of the physical machines 2 from among the applications AP specified in the processing in S32.

Subsequently, the machine determination unit 117 determines the physical machine 2 in which the free resources satisfy the predetermined condition as the physical machine 2 that activates the container 3 corresponding to the application AP specified in the processing in S34 (S35).

As in a case of the processing in S21, the machine determination unit 117 determines, for example, the physical machine 2 of which the usage rate of the CPU is equal to or less than the CPU threshold and the free space of the memory is equal to or larger than the memory threshold as the physical machine 2 that activates the container 3 corresponding to the application AP specified in the processing in S34.

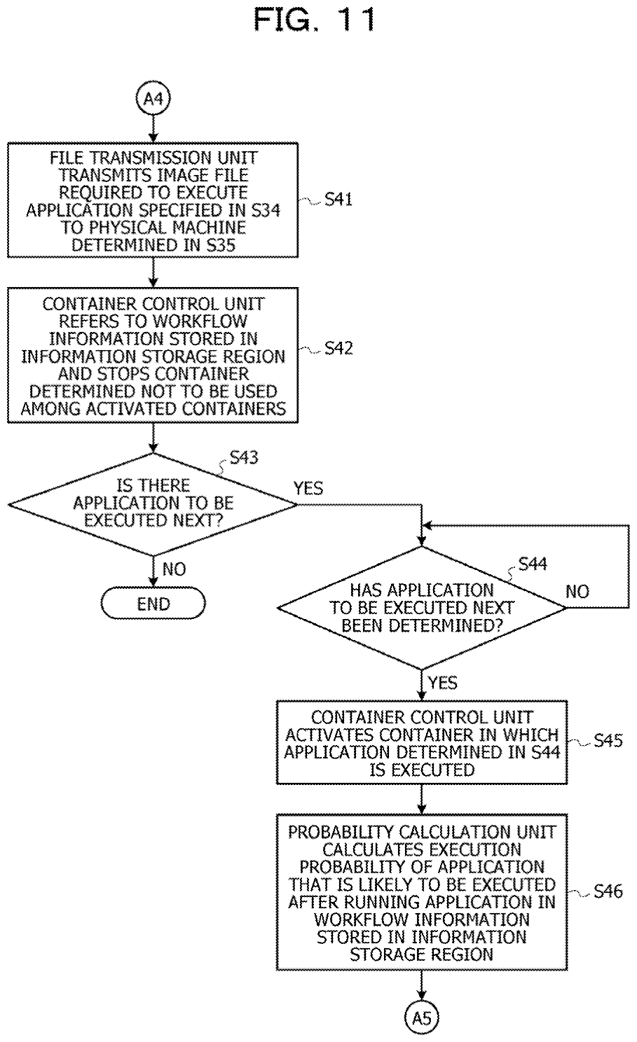

Moreover, as illustrated in FIG. 11, the file transmission unit 118 transmits the image file required to execute the application AP specified in the processing in S34 to the physical machine 2 determined in the processing in S35 (S41).

Note that, in the case of performing the processing in S31 and the subsequent steps, the management device 1 may not perform the processing in S32, the processing in S34, the processing in S35, and the processing in S41, for example. The management device 1 may not perform processing for storing the image file in the physical machine 2 that executes each application AP, as needed, for example.

Thereafter, the container control unit 114 refers to the workflow information 135 stored in the information storage region 130 and stops the container 3 that is determined not to be used from among the activated containers 3 (S42).

For example, the container control unit 114 refers to the workflow information 135 stored in the information storage region 130 and determines whether or not the application AP that is determined not to be executed after the running application AP is included in the applications AP that are executed in the activated container 3. Then, in a case of determining that the application AP that is determined not to be executed after the running application AP exists, the container control unit 114 stops the container 3 in which the application AP that is determined to exist is executed.

As a result, the management device 1 can further suppress the consumption of the physical resource of the physical machine 2.

Note that the information management unit 112 may update the workflow information 135 stored in the information storage region 130 as needed, for example, according to the execution of the processing in S23, the processing in S33, the processing in S41, and the processing in S42.

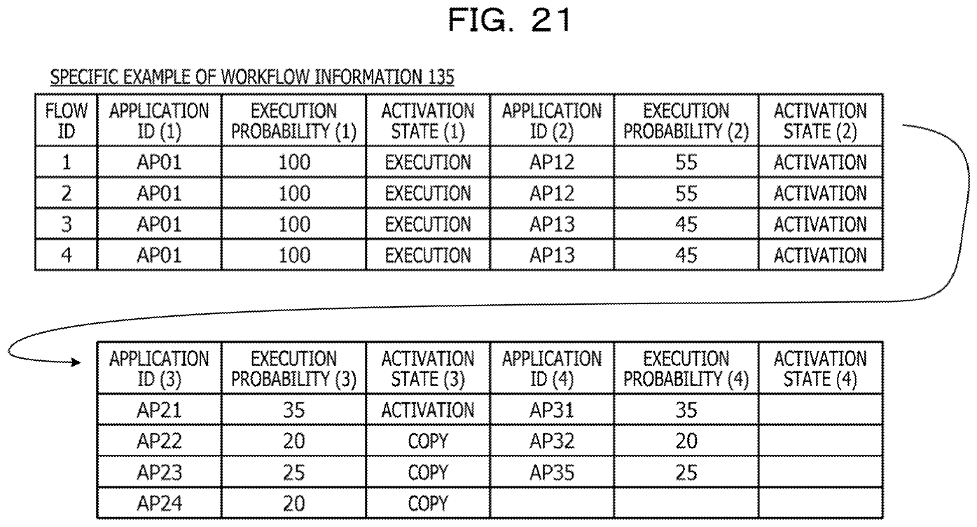

The information management unit 112 may set “execute” to the “activation state” corresponding to the running application AP in the container 3 activated in the processing in S23, for example, as illustrated in FIG. 21. Furthermore, the information management unit 112 may set “activate” to the “activation state” corresponding to the application AP executed in the container 3 activated in the processing in S33, for example. Furthermore, the information management unit 112 may set “copy” to the “activation state” corresponding to the application AP that stores (copies) the image file in the processing in S41 or the like, for example. Moreover, as described later, the information management unit 112 may set “stop” to the “activation state” corresponding to the application AP executed in the container 3 that is stopped in the processing in S42, for example.

Returning to FIG. 11, the container control unit 114 refers to the workflow information 135 stored in the information storage region 130 and determines whether or not an application AP to be executed after the running application AP exists (S43).

As a result, in a case where it is determined that the application AP to be executed after the running application AP does not exist (NO in S43), the management device 1 ends the execution of the main processing of the application control processing.

On the other hand, in a case where it is determined that the application AP to be executed after the running application AP exists (YES in S43), the management device 1 waits until an application AP to be executed next is determined according to the end of the execution of the running application AP (NO in S44).

Then, in a case where the application AP to be executed next is determined (YES in S44), the container control unit 114 activates a container 3 in which the application AP determined in the processing in S44 is executed and further executes the application AP determined in the processing in S44 (S45).

For example, in this case, the container control unit 114 determines whether or not the container 3 in which the application AP determined in the processing in S44 is executed has been already activated. Then, in a case where it is determined that the container 3 in which the application AP determined in the processing in S44 is executed has not been activated yet, the container control unit 114 activates the container 3 in which the application AP determined in the processing in S44 is executed.

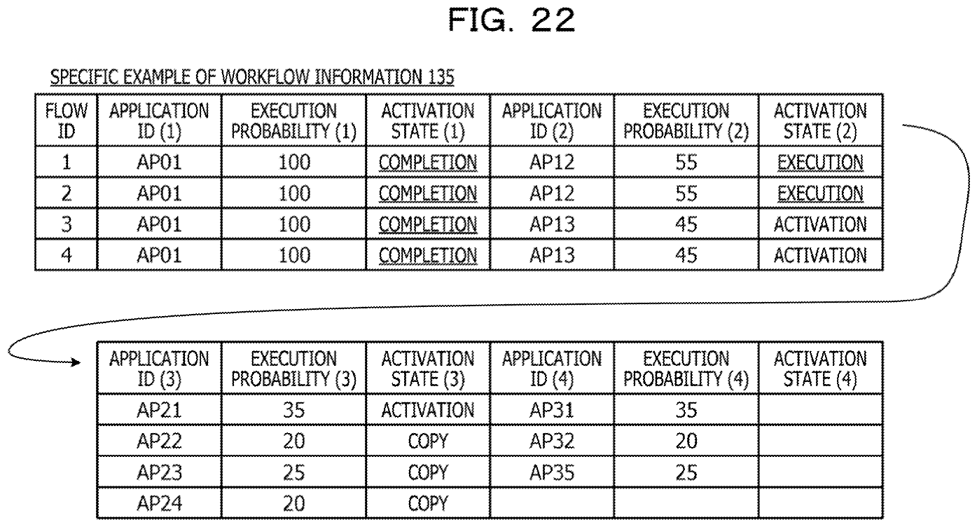

Note that, in this case, for example, as illustrated in the underlined portion in FIG. 22, the information management unit 112 sets “end” to the “activation state” corresponding to the application AP of which the execution ends, and sets “execute” to the “activation state” corresponding to the application AP of which execution is newly started.

Subsequently, the probability calculation unit 115 calculates an execution probability of an application AP that is likely to be executed after the running application among information included in the workflow information 135 stored in the information storage region 130 (S46). Then, the management device 1 executes the processing in S31 and subsequent processing again after the processing in S46.

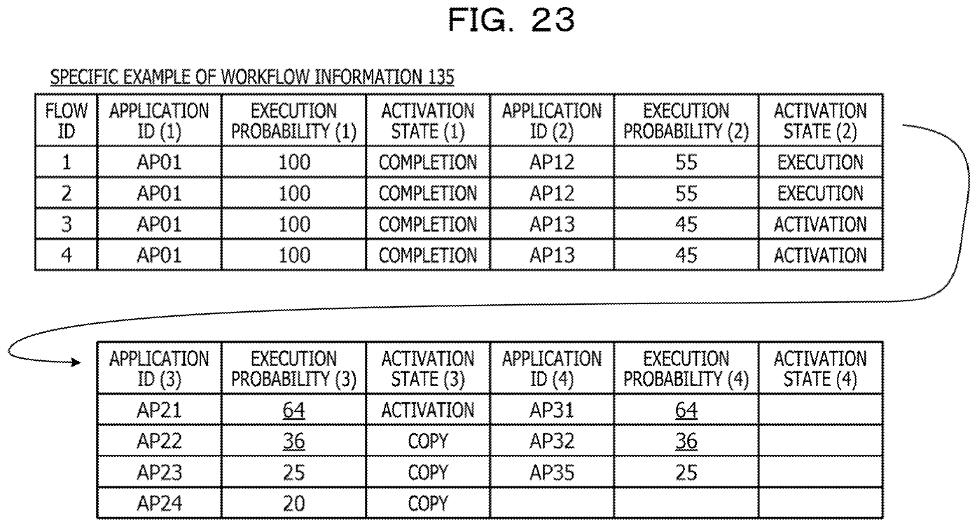

For example, in a case where the application AP of which the “application ID” is “AP12” is executed after the application AP of which the “application ID” is “AP01” is executed, the probability calculation unit 115 calculates a probability such that each of the applications AP of which the “application IDs” are “AP21”, “AP22”, “AP31”, and “AP32” is executed after the execution of the application AP of which the “application ID” is “AP12” as illustrated in FIG. 23.

For example, in the workflow information 135 illustrated in FIG. 22, the “execution probability” corresponding to the application AP of which the “application ID” is “AP12” is “55(%)”, the “execution probability” corresponding to the applications AP of which the “application IDs” are “AP21” and “AP31” is “35(%)”, and the “execution probability” corresponding to the applications AP of which the “application IDs” are “AP22” and “AP32” is “20(%)”. Therefore, the probability calculation unit 115 calculates a new execution probability corresponding to the applications AP of which the “application IDs” are “AP21” and “AP31” as “64(%)” by dividing “35(%)” by “0.55” corresponding to “55(%)”. Furthermore, the probability calculation unit 115 calculates a new execution probability corresponding to the applications AP of which the “application IDs” are “AP22” and “AP32” as “36(%)” by dividing “20(%)” by “0.55” corresponding to “55(%)”.

Then, as illustrated in the underlined portion in FIG. 23, for example, the information management unit 112 updates the “execution probability” corresponding to the applications AP of which the “application IDs” are “AP21” and “AP31” to “64(%)” and updates the “execution probability” corresponding to the applications AP of which the “application IDs” are “AP22” and “AP32” to “36(%)”.

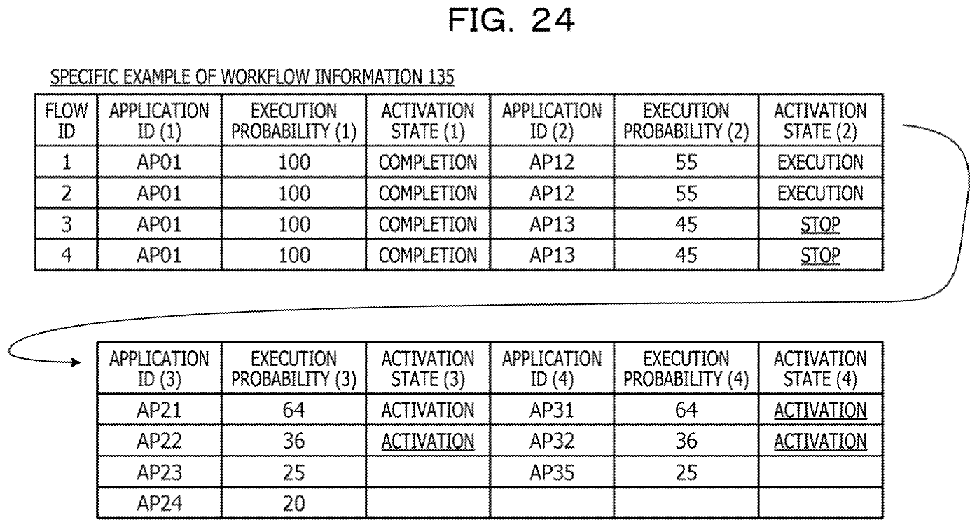

Thereafter, the second application specifying unit 116 determines that all execution probabilities of the applications AP of which the “application IDs” are “AP22”, “AP31”, and “AP32” are equal to or larger than 35(%) in the processing in S31 for the second time. Therefore, the container control unit 114 activates the container 3 in which each of the applications AP of which the “application IDs” are “AP22”, “AP31”, and “AP32” is executed in the processing in S33 for the second time. Then, as illustrated in the underlined portion in FIG. 24, for example, the information management unit 112 sets “activate” to the “activation state” corresponding to the applications AP of which the “application IDs” are “AP22”, “AP31”, and “AP32”.

Moreover, the container control unit 114 stops the container 3 (activated container 3) in which the application AP of which the “application ID” is “AP13” is executed in the processing in S42 for the second time. Then, as illustrated in the underlined portion in FIG. 24, for example, the information management unit 112 updates the “activation state” corresponding to the application AP of which the “application ID” is “AP13” to “stop”. Furthermore, for example, the information management unit 112 sets a blank to the “activation state” corresponding to the applications AP with the “application ID” of “AP23” and “AP24” (applications AP that are likely to be executed after the application AP with the “application ID” of “AP13”).

### Information Update Processing

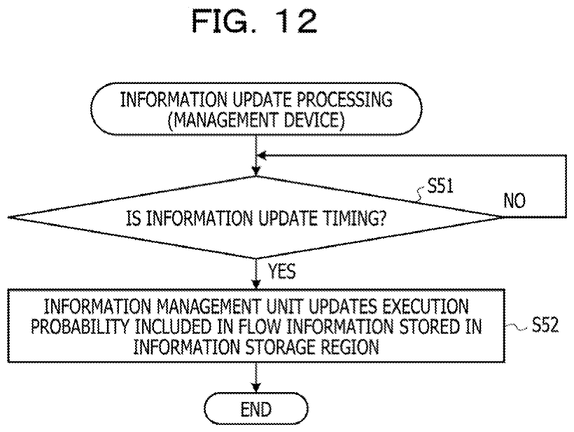

Next, processing for updating the flow information 133 (hereinafter, also referred to as information update processing) in the application control processing will be described. FIG. 12 is a flowchart for describing an information update device.

As illustrated in FIG. 12, the information management unit 112 waits, for example, until it becomes an information update timing (NO in S51). The information update timing may be, for example, a timing when the main processing of the application control processing ends. Furthermore, the information update timing may be a periodical timing, for example, once in an hour or the like.

Then, in a case where it becomes the information update timing (YES in S51), the information management unit 112 updates each execution probability included in the flow information 133 stored in the information storage region 130 (S52).

For example, the probability calculation unit 115 recalculates each execution probability included in the flow information 133 stored in the information storage region 130 (execution probability of each application AP). Then, as illustrated in FIG. 25, the information management unit 112 updates each execution probability included in the flow information 133 stored in the information storage region 130 to the recalculated execution probability.

As described above, in the case where the specific application AP included in a plurality of applications AP is executed in response to the processing request from the specific processing request source, the management device 1 according to the present embodiment refers to the information storage region 130 that stores the flow information 133 indicating the past execution order of the plurality of applications AP for each processing request source of the plurality of applications AP. Then, the management device 1 calculates an execution probability that each of one or more applications AP that are likely to be executed after the specific application AP is executed after the specific application AP executed in response to the processing request from the specific processing request source. Thereafter, the management device 1 specifies an application AP to be activated on the basis of the calculated execution probability, and activates the specified application AP to be activated.

For example, the management device 1 according to the present embodiment specifies the application AP that is highly likely to be executed after the specific application AP (application AP with high execution probability) on the basis of the past record of the execution order of the respective applications AP in a case where the processing request from the specific processing request source has been made in the past. Then, the management device 1 only activates the specified application AP in advance.

Thereby, the management device 1 in the present embodiment can predict with higher accuracy the application AP that is highly likely to be executed after the specific application AP. Therefore, the management device 1 can suppress the probability that an application AP that is not activated in advance is executed at the time of executing each application AP with the reception of the processing request. Therefore, the management device 1 can suppress the probability that the application AP is activated at the time of executing each application AP with the reception of the processing request, and can shorten the response time to the processing request.

Note that, in the example described above, it has been described that it is assumed that the first threshold used in the processing in S31 and the processing in S32 be determined in advance. However, the first threshold may be determined as needed, for example, according to the number of applications AP that are likely to be executed after the running application AP, or the like.

The first threshold may be, for example, a reciprocal of the number of applications AP that are likely to be executed after an application AP subsequent to the running application AP or may be a reciprocal of a number obtained by adding a predetermined number (for example, one) to the number of applications AP that are likely to be executed after an application AP subsequent to the running application AP.

Furthermore, the probability calculation unit 115 of the management device 1 may refer to the group information 136 stored in the information storage region 130 in the processing in S24. The group information 136 is information indicating each of the attributes of the user terminal. Then, the probability calculation unit 115 may specify, for example, the attribute corresponding to the event received in the processing in S11 among the attributes having the information included in the group information 136 stored in the information storage region 130. Thereafter, the probability calculation unit 115 may extract, for example, the workflow information 135 corresponding to each of the applications AP that are likely to be executed after the running application AP (the application AP specified in the processing in S12) from the information included in the flow information 133 corresponding to the specified attribute. Hereinafter, a specific example of the group information 136 will be described.

### Specific Example of Group Information

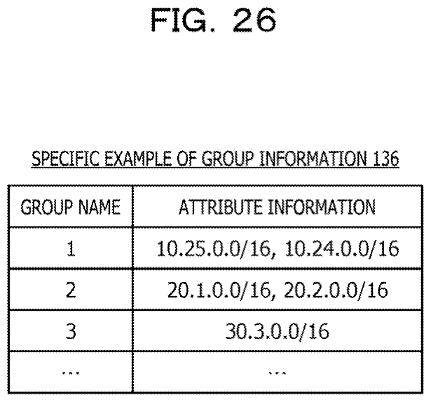

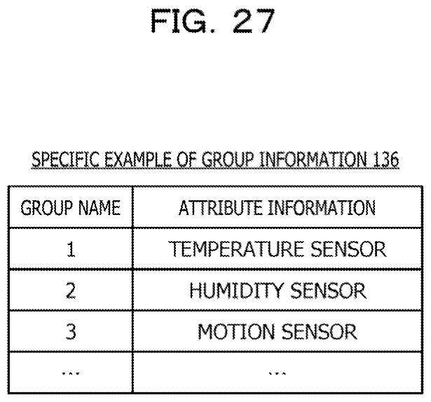

A specific example of the group information 136 will be described with reference to FIGS. 26 and 27.

The group information 136 illustrated in FIG. 26 and the like have “group name” for identifying each group and “attribute information” for identifying the attributes included in each group as items. For example, the IP address or the subnet corresponding to the user terminal is set in the “attribute information”. Furthermore, in the “attribute information”, for example, information indicating various sensor types (for example, temperature sensor, humidity sensor, pressure sensor, illuminance sensor, motion sensor, and the like), and types of computer (for example, server, desktop PC, node PC, smartphone, and the like), are set as the information indicating the device type of the user terminal. Moreover, in the “attribute information”, for example, information indicating a place of use (installation place) of the user terminal, and an operation method of the user terminal (for example, the presence or absence of use of a virtual machine, the presence or absence of installation of a graphics processing unit (GPU) or the like) are set.

In the group information 136 illustrated in FIG. 26, “1” is set as the “group name”, and “10.25.0.0/16” and “10.24.0.0/16” that are subnets corresponding to the user terminal are set as the “attribute information” in the information on the first row, for example. Furthermore, “2” is set as the “group name”, and “20.1.0.0/16” and “20.2.0.0/16” that are subnets corresponding to the user terminal are set as the “attribute information” in the information on the second row. Description of other information included in FIG. 26 is omitted.

For example, the example in FIG. 26 illustrates that the flow information 133 stored in the information storage region 130 is generated for each subnet of the user terminal. Therefore, in this case, the probability calculation unit 115 specifies the subnet corresponding to the user terminal from the information included in the processing request received from the user terminal and obtains the flow information 133 corresponding to the specified subnet in the processing in S24.

Furthermore, in the group information 136 illustrated in FIG. 27, “1” is set as the “group name” and “temperature sensor” that is the type of the user terminal is set as the “attribute information” in the information on the first row. Furthermore, “2” is set as the “group name” and “humidity sensor” that is the type of the user terminal is set as the “attribute information” in the information on the second row. The description of other information included in FIG. 27 will be omitted.

For example, the example in FIG. 27 illustrates that the flow information 133 stored in the information storage region 130 is generated for each device type (sensor type) of the user terminal. Therefore, in this case, the probability calculation unit 115 specifies the device type of the user terminal from the information included in the processing request received from the user terminal and refers the flow information 133 corresponding to the specified device type in the processing in S24.

Thereby, the management device 1 in the present embodiment can predict with higher accuracy the application AP that is highly likely to be executed after the specific application AP by referring to the flow information 133 corresponding to the attribute of the user terminal as the transmission source of the processing request.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an application control program for causing a computer to execute processing comprising:
in a case where a specific application included in a plurality of applications is executed in response to a processing request from a specific processing request source, referring to a storage unit that stores flow information that indicates a past execution order of the plurality of applications for each of the processing request sources of the plurality of applications, and calculating an execution probability that each of one or more applications that are likely to be executed after the specific application executed in response to the processing request from the specific processing request source among the plurality of applications is executed after the specific application executed in response to the processing request from the specific processing request source;
specifying an application to be activated from the one or more applications on a basis of the calculated execution probability; and
activating the specified application to be activated.

2. The non-transitory computer-readable recording medium according to claim 1, wherein
the processing of calculating includes
specifying applications of which the number of other applications to be executed after the specific application is executed in response to the processing request from the specific processing request source and before each application is executed among the plurality of applications is equal to or less than a predetermined number, as the one or more applications, and
calculating the execution probability that corresponds to each of the specified one or more applications.

3. The non-transitory computer-readable recording medium according to claim 1, wherein
the processing of specifying includes specifying an application of which the execution probability is equal to or larger than a first threshold among the one or more applications as the application to be activated.

4. The non-transitory computer-readable recording medium according to claim 3, wherein
the processing of specifying includes specifying an application of which the execution probability is less than the first threshold among the one or more applications as an application for which an image file required to execute each application is stored in another information processing device that executes each application.

5. The non-transitory computer-readable recording medium according to claim 1, wherein
the plurality of applications is applications executed in a plurality of containers, respectively, and
the processing of activating includes
activating a container in which the application to be activated is executed in another information processing device, and
activating the application to be activated in the activated container.

6. The non-transitory computer-readable recording medium according to claim 1, wherein
the processing request source of the plurality of applications is identification information of a terminal that has requested execution of at least one of the plurality of applications.

7. The non-transitory computer-readable recording medium according to claim 6, wherein
the identification information is an IP address or a subnet that corresponds to the terminal.

8. The non-transitory computer-readable recording medium according to claim 6, wherein
the identification information is information that indicates a type of the terminal.

9. An application control method comprising:
in a case where a specific application included in a plurality of applications is executed in response to a processing request from a specific processing request source, referring to a storage unit that stores flow information that indicates a past execution order of the plurality of applications for each of the processing request sources of the plurality of applications, and calculating an execution probability that each of one or more applications that are likely to be executed after the specific application executed in response to the processing request from the specific processing request source among the plurality of applications is executed after the specific application executed in response to the processing request from the specific processing request source;
specifying an application to be activated from the one or more applications on a basis of the calculated execution probability; and
activating the specified application to be activated.

10. The application control method according to claim 9, wherein
the processing of calculating includes
specifying applications of which the number of other applications to be executed after the specific application is executed in response to the processing request from the specific processing request source and before each application is executed among the plurality of applications is equal to or less than a predetermined number, as the one or more applications, and
calculating the execution probability that corresponds to each of the specified one or more applications.

11. The application control method according to claim 9, wherein
the processing of specifying includes specifying an application of which the execution probability is equal to or larger than a first threshold among the one or more applications as the application to be activated.

12. The application control method according to claim 11, wherein
the processing of specifying includes specifying an application of which the execution probability is less than the first threshold among the one or more applications as an application for which an image file required to execute each application is stored in another information processing device that executes each application.
